(19) United States
(12) Patent Application Publication
(10) Pub. No.: US 2026/0261173 A1
(43) Pub. Date: Sep. 3, 2026

(54) MOTOR

(71) Applicant: LG INNOTEK CO., LTD., Seoul (KR)

(72) Inventor: Chang Hyun PARK, Seoul (KR)

(73) Assignee: LG INNOTEK CO., LTD., Seoul (KR)

(21) Appl. No.: 18/878,545

(22) PCT Filed: Jun. 22, 2023
(86) PCT No.: PCT/KR2023/008675

§ 371 Date: Dec. 23, 2024

(30) Foreign Application Priority Data
Jun. 24, 2022 (KR) 10-2022-0077438

(51) Int. Cl. H02K 1/30

(52) U.S. Cl. CPC H02K 1/30

(57) ABSTRACT

The present invention may provide a motor including a shaft, a magnet coupled to the shaft, a stator disposed to correspond to the magnet, and a magnet holder disposed outside the magnet, wherein the magnet holder includes a first surface disposed to face an outer surface of the magnet, a second surface bent from the first surface, a third surface bent from the first surface and disposed to be spaced apart from the magnet in an axial direction, a fourth surface disposed to face the other surface of the magnet, a fifth surface which connects the third surface and the fourth surface, and a sixth surface bent from the fourth surface, the magnet includes an inner surface in contact with the shaft and the outer surface disposed to face the inner surface, the fourth surface is in contact with the other surface of the magnet, the second surface is disposed to overlap a portion of the outer surface of the magnet, and the sixth surface is in contact with an outer surface of the shaft.

### TECHNICAL FIELD

The present invention relates to a motor.

### BACKGROUND ART

A motor includes a shaft and a stator. The shaft may be a hollow shaft. A magnet may be attached to an outer circumferential surface of the shaft. In this case, the hollow shaft has a problem that it is difficult to arrange a location of the magnet.

This is because it is difficult to form a guide for arranging the magnet in consideration of hollow shaft machining. When there is no guide for arranging the magnet at the shaft, the magnet may be twisted when the magnet is over-molded. In addition, a magnet may be fixed to a shaft by taping a magnet holder formed of a composite material, but, under a high-temperature condition, there is a high risk that the magnet holder may be separated from the shaft.

### DISCLOSURE

### Technical Problem

The present invention is intended to solve the above-described problems and directed to providing a motor in which a coupling force between a shaft and a magnet holder can be secured under a high-temperature condition.

Objectives to be achieved by the present invention are not limited to the above-described objectives, and other objectives, which are not described above, may be clearly understood by those skilled in the art through the following specification.

### Technical Solution

The present invention to achieve the above objectives provides a motor including a shaft, a magnet coupled to the shaft, a stator disposed to correspond to the magnet, and a magnet holder disposed outside the magnet, wherein the magnet holder includes a first surface disposed to face an outer surface of the magnet, a second surface bent from the first surface, a third surface bent from the first surface and disposed to be spaced apart from the magnet in an axial direction, a fourth surface disposed to face the other surface of the magnet, a fifth surface which connects the third surface and the fourth surface, and a sixth surface bent from the fourth surface, the magnet includes an inner surface in contact with the shaft and the outer surface disposed to face the inner surface, the fourth surface is in contact with the other surface of the magnet, the second surface is disposed to overlap a portion of the outer surface of the magnet, and the sixth surface is in contact with an outer surface of the shaft.

An axial length of the sixth surface may range from 5% to 15% of an axial length of the magnet.

The second surface may be disposed to be spaced apart from the shaft in a radial direction.

The second surface may be in contact with one surface of the magnet.

The shaft may include a first region having a first inner diameter, a second region connected to one side of the first region in the axial direction and having a second inner diameter which is greater than the first inner diameter, and a third region connected to the other side of the first region and having a third inner diameter which is smaller than the first inner diameter, wherein the magnet may be in contact with an outer surface of the first region.

The sixth surface may be disposed to be closer to the third region than the second region in the axial direction.

An end of the sixth surface may be disposed to be closer to the third region than the third surface in the axial direction.

An axial length of the sixth surface may be smaller than a distance from an end of the sixth surface to an end of the first region in the axial direction.

A distance from an end of the sixth surface to an end of the first region in the axial direction may be smaller than an axial length of the magnet.

A radial length of the second surface may be smaller than a radial length of the third surface.

The third surface may be spaced apart from the magnet in the axial direction to form a space portion between the magnet holder and the magnet.

The magnet holder may include the third surface, the fifth surface, and a protrusion protruding from a lower end of the magnet holder in the axial direction, and the protrusion may have an annular shape.

### Advantageous Effects

According to one embodiment of the present invention, since a magnet holder includes a region to which a shaft is press-fitted, there is an advantage of securing a coupling force between the shaft and the magnet holder under a high-temperature condition.

According to one embodiment of the present invention, since a magnet holder formed as one can is used, there is an advantage of simplified assembly and a structure.

According to one embodiment of the present invention, since a fifth surface of the magnet holder is press-fitted onto the shaft, and a fourth surface connected to the fifth surface is in contact with the other end portion of the magnet, there is an advantage of increasing a fixing force for the magnet.

### DESCRIPTION OF DRAWINGS

FIG. 1 is a view illustrating a motor according to an embodiment.

FIG. 2 is a perspective view illustrating a shaft, a magnet, and a magnet holder.

FIG. 3 is a view illustrating the magnet holder before the magnet holder is assembled to the shaft.

FIG. 4 is a side cross-sectional view illustrating the shaft.

FIG. 5 is a top perspective view illustrating the magnet holder.

FIG. 6 is a bottom perspective view illustrating the magnet holder.

FIG. 7 is a side cross-sectional view illustrating the magnet holder.

FIG. 8 is a side cross-sectional view illustrating the magnet on which the magnet holder is mounted.

FIG. 9 is a side cross-sectional view illustrating the shaft on which the magnet and the magnet holder are disposed.

FIG. 10 is a plan view illustrating the shaft on which the magnet and the magnet holder are disposed.

### MODES OF THE INVENTION

Hereinafter, exemplary embodiments of the present invention will be described in detail with reference to the accompanying drawings.

However, the technical spirit of the present invention is not limited to some embodiments which will be described and may be implemented in a variety of different forms, and one or more components of the embodiments may be selectively combined, substituted, and used within the range of the technical spirit of the present invention.

In addition, unless clearly and specifically defined otherwise by the context, all terms (including technical and scientific terms) used herein can be interpreted as having meanings customarily understood by those skilled in the art, and the meanings of generally used terms, such as those defined in commonly used dictionaries, will be interpreted in consideration of contextual meanings of the related art.

In addition, the terms used in the embodiments of the present invention are considered in a descriptive sense only and not to limit the present invention.

In the present specification, unless specifically indicated otherwise by the context, singular forms include plural forms, and in a case in which “at least one (or one or more) among A, B, and C” is described, this may include at least one combination among all possible combinations of A, B, and C.

In addition, in descriptions of components of the present invention, terms such as “first,” “second,” “A,” “B,”“(a),” and “(b)” may be used.

The terms are only to distinguish one component from another component, and the essence, order, and the like of the components are not limited by the terms.

In addition, it should be understood that, when a first component is referred to as being “connected,” “coupled,” or “linked” to a second component, such a description may include both a case in which the first component is directly connected, coupled, or linked to the second component, and a case in which the first component is connected or coupled to the second component with a third component disposed therebetween.

In addition, when a first component is described as being formed or disposed “on” or “under” a second component, such a description includes both a case in which the two components are formed or disposed in direct contact with each other and a case in which one or more other components are interposed between the two components. In addition, when the first component is described as being formed “on or under” the second component, such a description may include a case in which the first component is formed at an upper side or a lower side with respect to the second component.

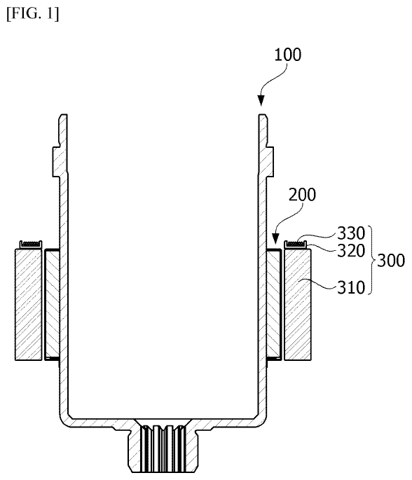

FIG. 1 is a view illustrating a motor according to an embodiment.

Referring to FIG. 1, a motor according to the embodiment may include a shaft 100, a magnet 200, a stator 300, and a magnet holder 400.

Hereinafter, the term “inward” is a direction toward the shaft 100 in a radial direction of the motor, and the term “outward” is a direction opposite to “inward.” In addition, a circumferential direction and the radial direction are defined based on an axial center of the motor.

The shaft 100 may be a hollow member of which one side is open. Both ends of the shaft 100 may be rotatably supported by bearings thereof in the axial direction. Portions of the shaft 100 of which outer diameters are different may be divided and disposed in the axial direction.

The magnet 200 is in contact with an outer circumferential surface of the shaft 100. The magnet 200 rotates in conjunction with the rotation of the shaft 100. The magnet 200 may be provided as a plurality of magnets 200.

The stator 300 is disposed outside the shaft 100 and the magnet 200. The stator 300 may include a stator core 310, an insulator 320 installed on the stator core 310, and a coil 330 wound around the insulator 320. The coil 330 forms a magnetic field. The stator core 310 may be formed as one core or formed by combining a plurality of divided cores. In addition, the stator core 310 may be formed by stacking a plurality of thin steel plates on each other but is not necessarily limited thereto. For example, the stator core 310 may be formed as one single part.

The magnet holder 400 serves to fix the magnet 200 to the shaft 100. The magnet holder 400 may be a cylindrical member formed of a metal material. The magnet holder 400 is fixed to the shaft 100 while disposed outside the magnet 200 to serve to fix the magnet 200 to the shaft 100 so that the magnet 200 is not separated from the shaft 100.

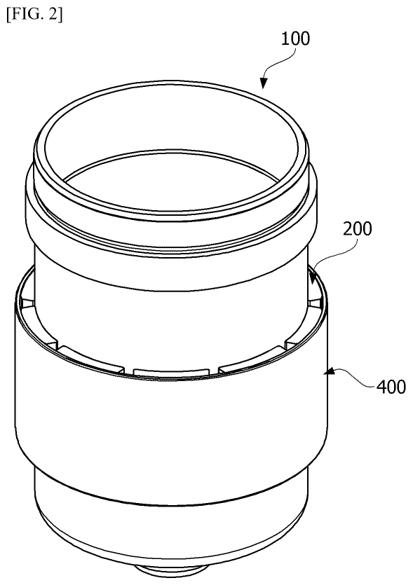

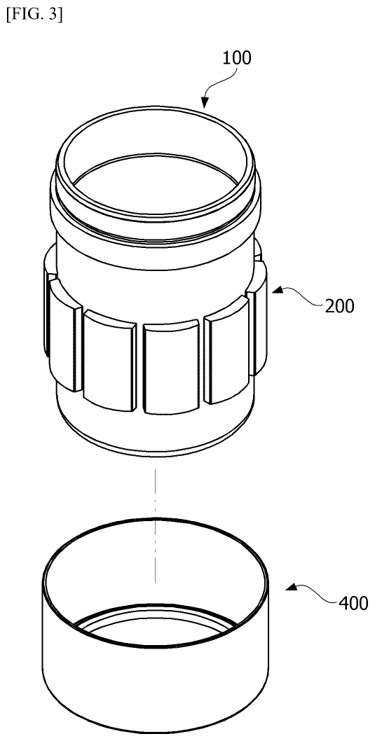

FIG. 2 is a perspective view illustrating the shaft 100, the magnet 200, and the magnet holder 400, and FIG. 3 is a view illustrating the magnet holder 400 before the magnet holder 400 is assembled to the shaft 100.

Referring to FIGS. 2 and 3, the plurality of magnets 200 may be fixed along an outer surface of the shaft 100. An adhesive may be applied between the magnet 200 and the outer surface of the shaft 100. The plurality of the magnets 200 may be disposed along a circumference of the shaft 100. The magnet holder 400 may be inserted and assembled from under the shaft 100 in the drawings.

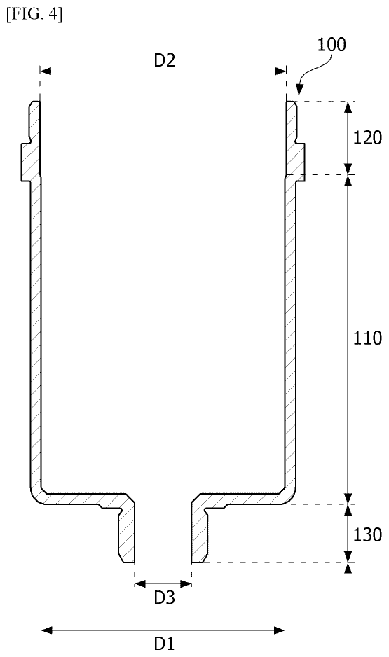

FIG. 4 is a side cross-sectional view illustrating the shaft 100.

Referring to FIG. 4, the shaft 100 is a hollow member. The shaft 100 may be divided into a first region 110, a second region 120, and a third region 130.

The first region 110 has a first inner diameter D1. The second region 120 is connected to one side of the first region 110 and has a second inner diameter D2 which is greater than the first inner diameter D1. The third region 130 is connected to the other side of the first region 110 and has a third inner diameter D3 which is smaller than the first inner diameter D1. A shaft of an external device may be inserted into the shaft 100 and coupled to the shaft 100.

Meanwhile, the magnet 200 and the magnet holder 400 are disposed on an outer surface of the first region 110.

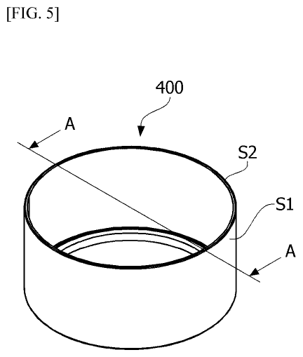

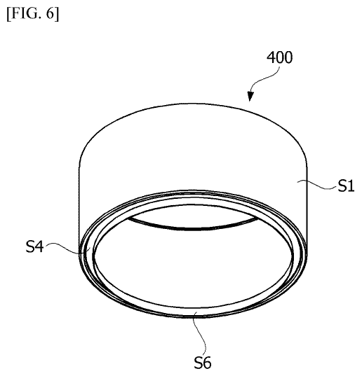

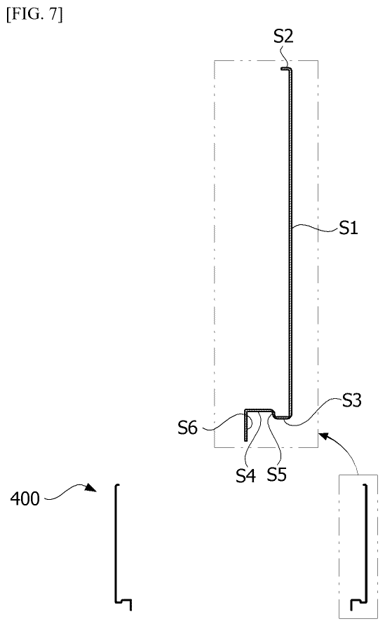

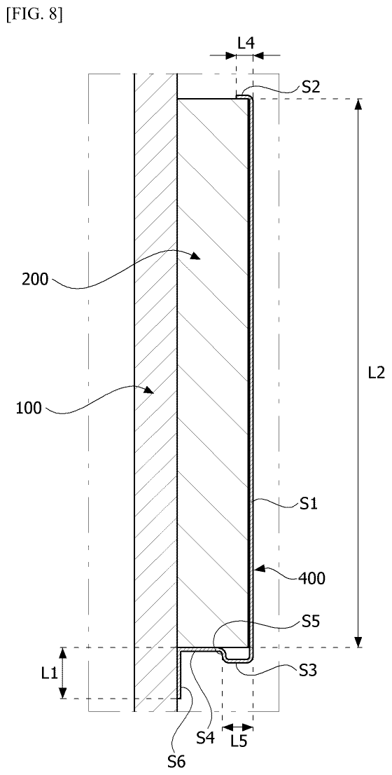

FIG. 5 is a top perspective view illustrating the magnet holder 400, and FIG. 6 is a bottom perspective view illustrating the magnet holder 400. FIG. 7 is a side cross-sectional view illustrating the magnet holder 400, and FIG. 8 is a side cross-sectional view illustrating the magnet 200 on which the magnet holder 400 is mounted.

Referring to FIGS. 5 to 8, the magnet holder 400 is a single part and coupled to the shaft 100 to surround the entire magnet 200. Particularly, since the magnet holder 400 is press-fitted onto the shaft 100, there is an advantage that a coupling force between the shaft 100 and the magnet holder 400 is mechanically high.

The entirety of the magnet holder 400 has a cylindrical shape. The magnet holder 400 may include a first surface S1, a second surface S2, a third surface S3, a fourth surface S4, a fifth surface S5, and a sixth surface S6.

The first surface S1 is disposed to face an outer surface of the magnet 200.

The second surface S2 is formed to be bent inward from one end portion of the first surface S1. The second surface S2 is disposed to face one surface of the magnet 200 in the axial direction.

The third surface S3 is formed to be bent inward from the other end portion of the first surface S1. The third surface S3 is disposed to face the other surface of the magnet 200 in the axial direction. In addition, the third surface S3 is disposed to be separated from the magnet 200 in the axial direction.

The fourth surface S4 is disposed to face the other surface of the magnet 200 in the axial direction. In addition, the fourth surface S4 is in contact with the other surface of the magnet 200 in the axial direction.

The fifth surface S5 is bent from the fourth surface S4 in the axial direction and connected to the third surface S3.

the sixth surface S6 is bent from the fourth surface S4. The sixth surface S6 is disposed to face the outer surface of the shaft 100, and the sixth surface S6 is in contact with the outer surface of the shaft 100.

When the magnet holder 400 is assembled to the shaft 100, the sixth surface S6 is press-fitted along the outer surface of the shaft 100. The sixth surface S6 may be press-fitted until the fourth surface S4 comes into contact with the other surface of the magnet 200. Since the fourth surface S4 supporting the other surface of the magnet 200 is directly connected to the sixth surface S6 press-fitted onto the shaft 100, the magnet 200 may be effectively prevented from moving not only in the radial direction but also in the axial direction.

An axial length L1 of the sixth surface S6 may range from 5% to 15% of an axial length L2 of the magnet 200. When the axial length L1 of the sixth surface S6 is smaller than 5% of the axial length L2 of the magnet 200, since a fixing force of the magnet holder 400 is small with respect to a size of the magnet 200, there is a possibility that the magnet 200 is separated. Conversely, when the axial length L1 of the sixth surface S6 is greater than 15% of the axial length L2 of the magnet 200, it is difficult to press-fit the magnet holder 400 to the shaft 100, and there is a possibility that the magnet holder 400 is deformed.

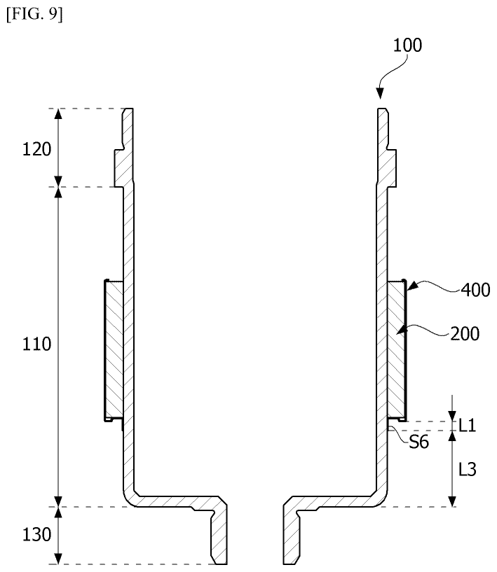

Meanwhile, the axial length L1 of the sixth surface S6 may be smaller than a distance K1 (see FIG. 9) from an end of the sixth surface S6 to an end of the first region in the axial direction.

Meanwhile, since the third surface S3 is disposed to be spaced apart from the magnet 200 in the axial direction, a space portion SP is formed between the magnet 200 and the third surface S3. An annular protrusion PT may be formed on a lower end of the magnet holder 400 due to the space portion SP.

FIG. 9 is a side cross-sectional view illustrating the shaft 100 on which the magnet 200 and the magnet holder 400 are disposed.

Referring to FIG. 9, the sixth surface S6 is disposed to be closer to the third region 130 than the second region 120 of the shaft 100 in the axial direction. In addition, the end of the sixth surface S6 is disposed to be closer to the third region 130 than the third surface S3 in the axial direction. Since the magnet holder 400 is assembled to the other end portion of the shaft 100 on which the third region 130 is formed, the sixth surface S6 is located close to the third region 130 of the shaft 100 in the axial direction. When the sixth surface S6 is located away from the third region 130 of the shaft 100 in the axial direction, since a length to pass along the outer surface of the shaft 100 for press-fitting increases, the sixth surface S6 should be located close to the third region 130 in the axial direction.

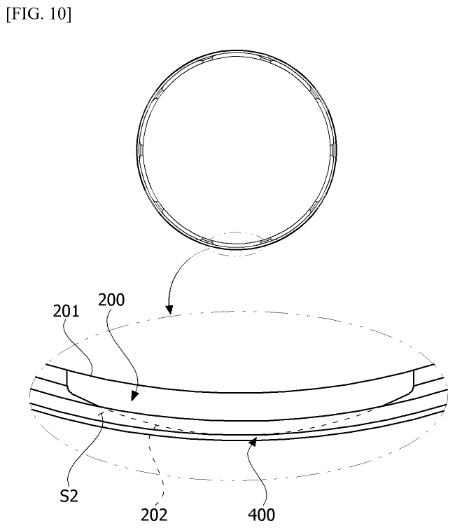

FIG. 10 is a plan view illustrating the shaft 100 on which the magnet 200 and the magnet holder 400 are disposed.

Referring to FIGS. 8 and 10, the second surface S2 of the magnet holder 400 is formed to cover one surface of the magnet 200. The second surface S2 is bent inward from the first surface S1 in the radial direction and is in contact with one surface of the magnet 200. The second surface S2 and the magnet 200 are disposed to partially overlap in the axial direction. The second surface S2 prevents the magnet 200 from being separated in the axial direction.

The second surface S2 may be formed through bending after that the magnet holder 400 is assembled to cover the magnet 200. Accordingly, the second surface S2 is disposed to be spaced apart from the shaft 100 in the radial direction.

In addition, since bending for forming the second surface S2 is performed while the sixth surface S6 is press-fitted onto the shaft 100, a radial length LA of the second surface S2 should be minimized to prevent deformation of the sixth surface S6.

Accordingly, the magnet 200 may include an inner surface in contact with the shaft 100 and the outer surface disposed to face the inner surface, and the second surface S2 may be disposed to overlap only a portion of the outer surface of the magnet 200 in the axial direction. In this case, the radial length L4 of the second surface S2 may be smaller than a radial length L5 of the third surface S3.

Meanwhile, a length of the sixth surface S6 passing along the outer surface of the shaft 100 for press-fitting should not be long if possible. For example, the distance K1 from the end of the sixth surface S6 to the end of the first region 110 in the axial direction may be smaller than the axial length L2 of the magnet 200.

The motor according to exemplary embodiments of the embodiment motor have been specifically described above with reference to the accompanying drawings.

The above-described embodiments should be considered in a descriptive sense only and not for purposes of limitation, and the scope of the present invention is defined not by the detailed description but by the appended claims. In addition, it should be interpreted that the scope of the present invention encompasses all modifications and alterations derived from meanings and the scope and equivalents of the appended claims.

1-10. (canceled)

11. A motor comprising:
a shaft;
a magnet coupled to the shaft;
a stator disposed to correspond to the magnet; and
a magnet holder disposed outside the magnet,
wherein the magnet holder has a region in contact with a radial outer surface of the magnet, a region in contact with an outer circumferential surface of the shaft, a region in contact with an axial one end face of the magnet, a region in contact with an axial the other end face of the magnet, a connecting region connecting a region in contact with an axial the other face of the magnet with a region in contact with an outer circumferential surface of the shaft.

12. The motor of claim 11, wherein a portion of the connecting region is in contact with an axial the other end face of the magnet and another portion of the connection region is spaced apart from the axial the other end face of the magnet.

13. The motor of claim 11, wherein the magnet holder includes:
a first surface contacts with a radial outer surface of the magnet,
a second surface bent from the first surface and contacts with the axial one end face of the magnet,
a third surface bent from the first surface and is spaced apart from with the axial the other end face of the magnet,
a fourth surface contacts with the axial the other end face of the magnet,
a fifth surface which connects the third surface and the fourth surface, and
a sixth surface contacts with an outer circumferential surface of the shaft,
wherein the second surface disposed to axially overlap a portion of an axial one end face of the magnet.

14. The motor of claim 11, wherein the axial length of the sixth surface ranges from 5% to 15% of the axial length of the magnet.

15. The motor of claim 11, wherein the second surface is disposed to be spaced apart from the shaft in a radial direction.

16. The motor of claim 11, wherein the second surface is in contact with one surface of the magnet.

17. The motor of claim 11, wherein the shaft includes:
a first region having a first inner diameter;
a second region connected to one side of the first region in an axial direction and having a second inner diameter which is greater than the first inner diameter; and
a third region connected to the other side of the first region and having a third inner diameter which is smaller than the first inner diameter,
wherein the magnet is in contact with an outer surface of the first region.

18. The motor of claim 17, wherein the sixth surface is disposed to be closer to the third region than the second region in the axial direction.

19. The motor of claim 17, wherein an end of the sixth surface is disposed to be closer to the third region than the third surface in the axial direction.

20. The motor of claim 17, wherein an axial length of the sixth surface is smaller than a distance from an end of the sixth surface to an end of the first region in the axial direction.

21. The motor of claim 17, wherein a distance from an end of the sixth surface to an end of the first region in the axial direction is smaller than an axial length of the magnet.

22. The motor of claim 11, wherein a radial length of the second surface is smaller than a radial length of a third surface.

23. A shafts with a hollow shape;
a plurality of magnets coupled along an outer circumferential surface of the shaft;
a stator disposed around the plurality of magnets; and
a magnet holder made of metal pressed into the shaft to enclose an outer surface of the magnets,
wherein at least a portion of an axial one end face of the magnets is exposed to an exterior of the magnet holder, and an axial the other end face of the magnets is located on an interior of the magnet holder.

24. The motor of claim 23, wherein the magnet holder contacts with the axial one end face of the magnet and the axial the other end face of the magnet.

25. The motor of claim 23, wherein a space formed between the axial the other end face of the magnet and the magnet holder.

26. The motor of claim 23, wherein an area in which the magnet holder is pressed into the shaft is adjacent to the axial one end face of the magnet.

27. The motor of claim 23, wherein the axial length of the area in which the magnet holder is pressed into the shaft is within 5% to 15% of the axial length of the magnet.
